(19) United States
(12) Patent Application Publication
(10) Pub. No.: US 2013/0077729 A1
(43) Pub. Date: Mar. 28, 2013

(54) METHOD OF SEGMENTING AND PACKAGING IRRADIATED COMPONENTS

(71) Applicant: PETER F. DAVIN, Jefferson Hills, PA (US)

(72) Inventor: PETER F. DAVIN, Jefferson Hills, PA (US)

(73) Assignee: WESTINGHOUSE ELECTRIC COMPANY LLC, CRANBERRY TOWNSHIP, PA (US)

(21) Appl. No.: 13/612,909

(22) Filed: Sep. 13, 2012

Related U.S. Application Data
(60) Provisional application No. 61/537,704, filed on Sep. 22, 2011.

(51) Int. Cl. G21C 19/32

(52) U.S. Cl. 376/272; 976/DIG. 272

(57) ABSTRACT

A method of segmenting and packaging an irradiated hardware component for storage or shipment. Radiological and physical characteristics of the components are first mapped over its surface. A segmenting plan and a loading plan is then determined that sets forth where over the surface of the components lateral segments are to be made from a map obtained from the mapping step taken into consideration any licensing restrictions and requirements of the facility in which the casks is to be stored with the view to maximizing the loading of the casks. The irradiated components are then segmented in accordance with the segmenting plan and loaded into the casks in accordance with the loading plan.

### CROSS REFERENCE TO RELATED APPLICATIONS

This application claims priority UNDER 35 U.S.C. §119(e) from U.S. Provisional Application Ser. No. 61/537,704, filed Sep. 22, 2011, entitled “Method of Segmenting and Packaging Retired Irradiated Hardware” and is related to patent application Ser. No. ______, entitled “Method of Segmenting Irradiated Boiling Water Reactor Control Rod Blades,” filed concurrently herewith (Attorney Docket CLS-UFS-014 UTILITY).

### BACKGROUND

1. Field

This invention relates generally to the storage, transportation and/or disposal of highly radioactive components, and more particularly, to a method for maximizing the loading of such components in storage and transportation casks.

2. Related Art

One type of commonly used boiling water nuclear reactor employs a nuclear fuel assembly comprised of fuel rods surrounded by a fuel channel. Each fuel channel of a boiling water reactor fuel assembly typically consists of a hollow, linear, elongated, four-sided channel of integral construction, which, except for its rounded corner edges, has a substantially square cross section. Commonly, each channel is roughly 14 feet (4.27 meters) long by five inches (12.7 cms.) square and laterally encloses a plurality of elongated fuel elements. The fuel elements are arranged to allow for the insertion of a cruciform shaped control rod, which, during reactor operation, is movable vertically to control the nuclear reaction. The control rods typically include an upper portion having a handle and four upper rollers for guiding the control rod as it moves vertically and a lower portion comprising a lower casting and lower ball rollers. The main body structure includes four blades or panels which extend radially from a central spline. Preferably, the blades extend longitudinally to a height that substantially equals the height of the fuel elements, which is approximately 12 feet (3.66 meters). The width of the control rods at the blade section is approximately twice the width of the panels, which is in the order of ten inches (25.4 cms.) and the blades are approximately 2.8 in. (7 mm) thick.

Following functional service, boiling water reactor control rod blades, fuel channels, low power range monitors and/or other irradiated components (hereinafter severally and collectively referred to as “irradiated hardware”) are difficult to store and dispose of because of their size, configuration, embrittled condition and radiological activity. Heretofore, within the United States, in-pool storage of certain irradiated hardware has been extremely space inefficient and with regard to all irradiated hardware, dry cask storage is not currently readily available. Accordingly, boiling water reactor operators necessarily dispose of irradiated hardware as soon as reasonably practical.

Irradiated hardware is typically Class C low level radioactive waste as defined and determined pursuant to 10 CFR §61 and related regulatory guidance, e.g., NRC's Branched Technical Position on Concentration Averaging and Encapsulation. Since Jul. 1, 2008, low level radioactive waste generators within the United States that are located outside the Atlantic Compact (Connecticut, New Jersey and South Carolina) have not had access to Class B or Class C, low level radioactive waste disposal capacity. Lack of disposal capacity has caused boiling water reactor operators considerable spent fuel pool overcrowding. Though currently very uncertain and subject to numerous regulatory and commercial challenges, Class B and Class C low level radioactive waste disposal capacity for the remainder of the United States low level radioactive waste generators is anticipated in the relatively near future. Even when waste disposal sites become available much of the irradiated hardware will be difficult and expensive to ship because of their size and configuration unless their volume can be significantly reduced and tightly compacted into licensed shipping casks.

Accordingly, it is an object of this invention to provide a method of segmenting and packaging irradiated hardware that will safely and compactly load the irradiated hardware into licensed shipping casks for transport or storage.

Furthermore, it is an object of this invention to provide such a method that will satisfy all licensing restrictions and requirements of the disposal site.

### SUMMARY

These and other objects are achieved by an improved method of segmenting and packaging an irradiated component for storage or shipment. The method includes the step of mapping a radiological and/or a physical characteristic of the irradiated hardware over a surface thereof. The method determines any radiological and physical licensing restrictions on the characteristic associated with a cask in which the irradiate hardware is to be placed for storage or shipment. The method then determines a segmenting plan and a loading plan that sets forth where over the surface of the component the component is to be segmented from the map obtained from the mapping step and the licensing restrictions, so that the cask receives a substantially maximum load that the cask can safely handle without violating the licensing restrictions. The irradiated hardware is then segmented in accordance with the segmenting plan and the cask is loaded with the segments in accordance with the loading plan. Preferably, the radiological characteristic is one or more of isotopic content and radiation levels and the physical characteristic is one or more of size, shape, metallurgy and weight. In one embodiment, the mapping step is performed by scanning a sensor over the surface of the irradiated hardware and recording and characterizing the sensor output. Preferably, the segmenting plan and the loading plan are determined together to maximize the load in the cask. In addition, the licensing restrictions may include an acceptance criteria of the waste disposal facility that the cask will be transported to.

### BRIEF DESCRIPTION OF THE DRAWINGS

A further understanding of the invention claimed hereafter can be gained from the following description of the preferred embodiments when read in conjunction with the accompanying drawings in which:

FIG. 1 is a simplified schematic of a boiling water reactor fuel channel enclosed within a container formed from an inner and outer sleeve and placed within the walls of a full length compactor that is situated in a spent fuel pool;

FIG. 2 is a perspective view of a boiling water reactor control rod; and

FIG. 3 is a perspective view of one panel of the control rod of FIG. 2.

### DESCRIPTION OF THE PREFERRED EMBODIMENT

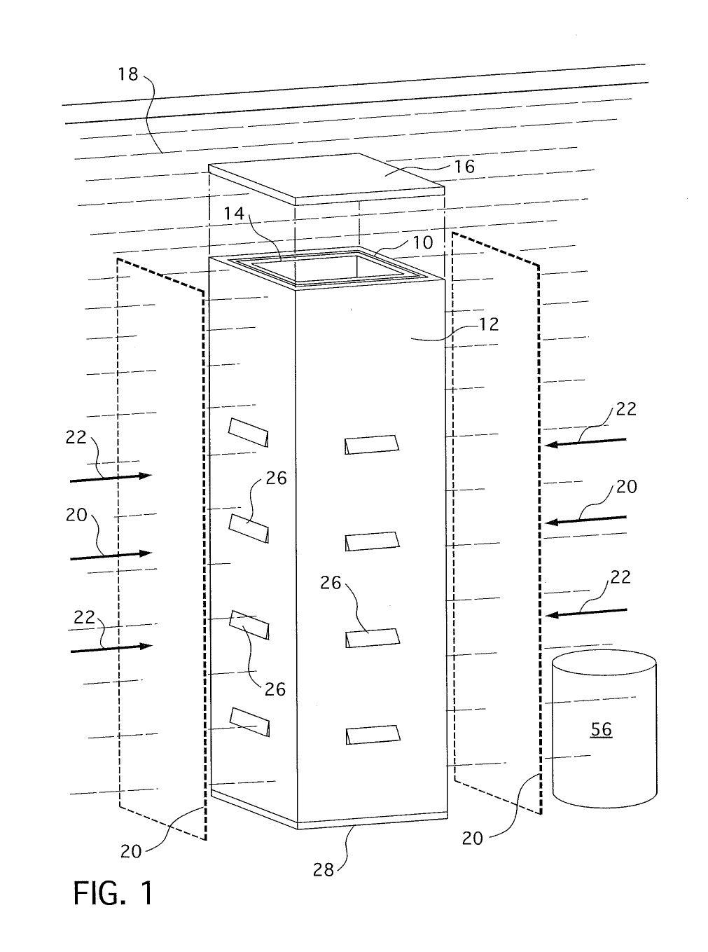

As previously mentioned, following functional service, boiling water reactor irradiated hardware components are difficult to store and dispose of because of their size, configuration, embrittled condition and radiologic history. To make those components easier to store and package, different forms of consolidation have been proposed. For example, as described in application Ser. No. ______ [Attorney Docket No. CLS-UFS-014 UTILITY], filed concurrently herewith, and as shown in FIG. 1, a fuel assembly fuel channel 10 is inserted into an outer sleeve 12 that is sealed on top by a top cover 16 and a bottom cover 28. The sleeve 12, bottom cover 28 and top cover 16 completely seal the fuel channel 10 within the interior of the sleeve 12. Alternatively, the sleeve 12 and bottom cover 28 can be constructed as an integral can in which the fuel channel 10 can be loaded and sealed by the top cover 16. The sleeve or can completely encompasses the channel's length and is preferably made from a malleable metal such as aluminum, copper or other relatively malleable inexpensive metal. Portions of the sleeve or can 12 (i.e., sidewalls, top and/or bottom) are perforated and screened or otherwise trapped to allow water to escape without permitting debris within the sleeve enclosure from escaping. Once the fuel channel is secured with the sleeve enclosure 12, the enclosure will be subjected to a full lengthy hydraulic compactor 20 which will compact the sleeve enclosure in the lateral direction, i.e., a compacting force applied laterally to opposite sides of the sleeve enclosure, preferably over the entire length of its elongated dimension. The sleeve enclosure will then contain shattered fuel channel material which will be isolated by the sleeve from the spent fuel pool.

Following compaction, the sleeve enclosure containing the fuel channel may be laterally segmented to a desired length as identified by the steps of the method claimed hereafter by use of hydraulic shears 22. As explained hereafter, the physical limitations of the storage facility and/or transport cask and the radiation levels of the incremental sections of the sleeve containing the fuel channel, will dictate the optimal location along the length of the fuel channel at which lateral segmentation is desired. The outer sleeve 12 may also have an inner sleeve 14 that extends at least the length the fuel channel 10. The inner sleeve 14 is inserted within the fuel channel and the top of the inner sleeve 14 may be drawn to the top of the outer sleeve 12 and the bottom of the inner sleeve 14 may be drawn to the bottom of the outer sleeve 12 in place of the top 16 and bottom 28 seals previously noted.

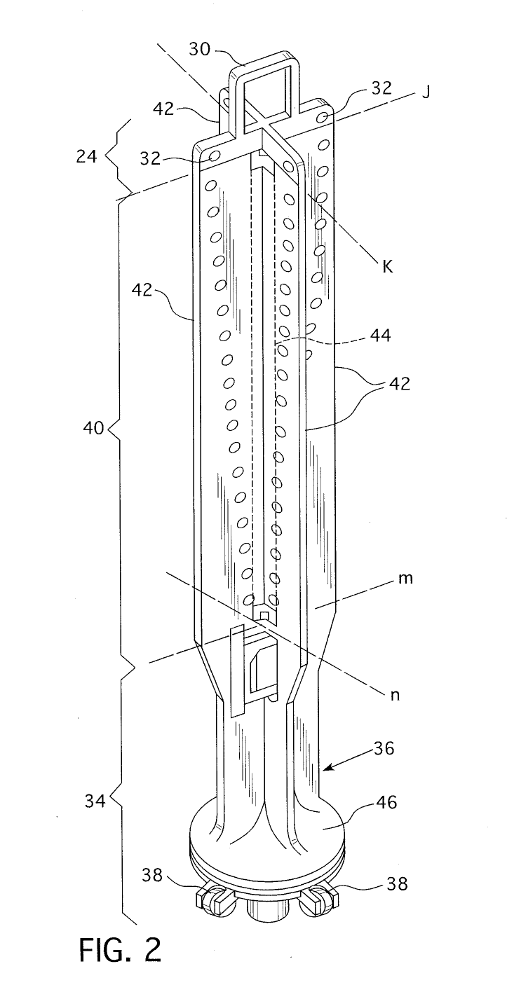

Another piece of irradiated hardware that boiling water reactor operators have difficulty storing and disposing of, because of their size, configuration, embrittled condition and radiological activity following functional service, is the control rod blade, such as the one illustrated in FIG. 2. The control rod blade comprises an upper portion 24 having an upper handle 30 and four upper ball rollers 32; a lower portion 34 having a lower casting 36 and lower rollers 38; and a main blade structure 40 therebetween. The main blade structure 40 includes four panels or blades 42 arranged in a cruciform shape about a central spline 44. According to one proposed method of compaction, lower portion 34 is removed by cutting approximately in a plane defined by lines m and n, and the upper portion 24 is removed by cutting in a transverse plane defined by lines j and k. Generally, the principal components of a control rod blade are the lifting handle 30, the stellite roller bearings 32 and 38, the lower portion 34 containing the velocity limiter 46 and the cruciform shape main body 40 including the blades or panels 42 and the central spline 44. To consolidate the control rod blade section 40 the upper portion 24 and the lower portion 34 are first removed. To achieve lateral segmentation of the blade section 40, two cuts are made vertically along the spline 44, 90° apart to separate the blades 42 into four separate panels. Once the blades are separated lateral segmentation may begin.

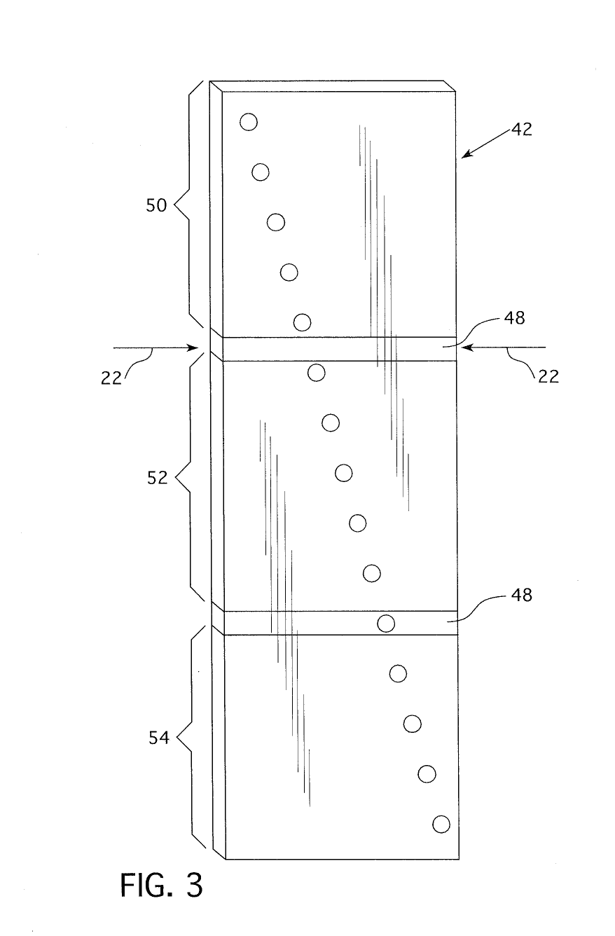

The cruciform shaped main body 40 is comprised of four shaped metallic panels 42 of metallic tubes containing powdered boron carbide or other neutron absorbing material that are welded together and to the central spline 44 lengthwise at opposing angles to form the cruciform shape. Because of the radioactive nature of the control rod, it is necessary for the volume reduction process to be performed under water, most preferably in the spent fuel pool. To separate the control rod into practically transportable segments it will be necessary to laterally segment the main body portion 40. However, under water lateral segmentation of the panels 42 will rupture both the sheathing and the tubes contained with the sheathing of the panels 42, thereby exposing the spent fuel pool to unwanted debris in the form of sheathing material, tubes and boron carbide. Embrittlement of the control rod blades caused by the extended neutron exposure that they would have experienced within the reactor compounds the difficulty of the lateral segmentation process. As in the case of the reactor fuel channels, and as will be explained in more detail hereafter, both physical and radiological criterion will dictate the optimal location along the length of the panel 42 at which lateral segmentation is desired to obtain maximum density packaging for transportation or storage. In other words, the configurations of the transport casks, the intended placement of a separated segment of a panel within the transport casks, and the radiation intensity of the segment will all contribute to determine at what elevation along the panel 42 lateral segmentation should be made. Once the desired location of lateral segmentation of the panel 42 is determined, a preformed band of malleable metal will be slid along the length of the panel to that location or wrapped around the panel at that location. Two such bands 48 are shown in FIG. 3, however, it should be appreciated that the upper panel segment 50, middle panel segment 52 and lower panel segment 54 may or may not be of equal length and the number of panel segments and the number of bands 48 employed will vary depending upon the foregoing dictates. The panels 42 with the band 48 positioned as described is crimped at the desired point of lateral segmentation and several inches to either side thereof to seal off both adjoining segments being separated at the point of demarcation. Lateral segmentation of both the crimped panel and band is achieved using a hydraulic shear, figuratively illustrated by reference character 22. The crimped band 21 is intended to limit or eliminate panel sheathing spring back and to capture shattered sheathing and neutron absorbing material within the tubes within the sheathing that has been embrittled by neutron exposure. Once sheared, the panel sections 50, 52 and 54 may be handled and packaged in accordance with one or more embodiments of the method claimed hereafter.

In accordance with one embodiment of this invention, the irradiated hardware is characterized for cask shipment by passing a sensor, such a radiation detector, over the surface of the irradiated hardware component to determine the dose rate and isotopic content of various locations on the component. The irradiated hardware can be then characterized by using commercially available software, such as the RADMAN software available from WMG Inc., Peekskill, N.Y. or software available from DW James Consulting LLC, North Oak, Minn. Each of the components of the irradiated hardware to be packaged is then mapped into segments. For irradiated hardware that requires lateral segmentation in order to be loaded into a shipping cask 56, boundaries of the segments where cuts are to be made are determined by using a combination of physical and radiological information. The physical information comprises one or more of the size, shape and weight of each segment and those of some or all of the remaining segments to be loaded into the cask 56. The radiological information may comprise the isotopic content and radioactivity of the segments. The boundaries are determined together with the generation of a cask loading plan that will maximize the loading of a shipping cask in which the irradiated hardware is to be placed; taking into consideration, the acceptance criteria of the waste disposal facility that the cask is to be transported to or stored in, the metallurgy, isotopic content, weight and operating history of the segments and the isotopic signature of the plant. The irradiated hardware is then cut or sheared along the boundaries and loaded into the cask according to the loading plan. For example, in the most simplistic form of the method, the lateral cuts will be determined so that the segments do not exceed the weight and dimensional loading limitations of the cask and the loading plan will load the more radioactive segments towards the center of the cask. In a more sophisticated example, the mapping plan and the loading plan will be treated as a three-dimensional problem and solved as a simultaneous equation by a computer program.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A method of segmenting and packaging an Irradiated Hardware component for storage or shipment comprising the steps of:
mapping a radiological and/or a physical characteristic over a surface of the component;
determining any radiological and physical licensing restrictions on the characteristic associated with a cask in which the component is to be placed for storage or shipment;
determining a segmenting plan and a loading plan that sets forth where over the surface of the component is to be segmented from a map obtained from the mapping step and the licensing restrictions, so that the cask receives a substantially maximum load that the cask can safely handle without violating the licensing restrictions;
separating the component into segments in accordance with the segmenting plan; and
loading the cask with the segments in accordance with the loading plan.

2. The method of claim 1 wherein the radiological characteristic is one or more of isotopic content and radiation levels.

3. The method of claim 1 wherein the physical characteristic is one or more of size, shape, metallurgy and weight.

4. The method of claim 1 wherein the mapping step is performed by scanning a sensor over the surface of the component and recording a sensor output.

5. The method of claim 4 wherein the mapping step includes the step of characterizing the sensor output to facilitate segmentation.

6. The method of claim 1 wherein the segmenting plan and the loading plan are determined together to maximize the load in the cask.

7. The method of claim 1 wherein the licensing restrictions include an acceptance criteria of a waste disposal facility that the cask will be transported to.
